(19) United States
(12) Patent Application Publication
(10) Pub. No.: US 2015/0133075 A1
(43) Pub. Date: May 14, 2015

(54) Wireless Communication Device

(71) Applicant: Ju Hwan Lee, Seoul (KR)

(72) Inventor: Ju Hwan Lee, Seoul (KR)

(21) Appl. No.: 14/537,968

(22) Filed: Nov. 11, 2014

(30) Foreign Application Priority Data
Nov. 11, 2013 (KR) 10-2013-0136477

(51) Int. Cl. H04W 4/22; H04M 1/18; H04M 1/21

(52) U.S. Cl. CPC H04W 4/22; H04M 1/21; H04M 1/18
USPC 455/404.2

(57) ABSTRACT

Disclosed is a wireless communication apparatus of a ship for security, safety and emergency situation at sea, wherein position information may be transmitted to or received from a control center or a rescue center through a GPS receiver and may be connected to a display apparatus. When the situation is normal, the apparatus is engaged to a holding unit. In case the situation is in emergency, the apparatus separates from the holding unit and becomes possible to transmit the current position information to the head office or receive the same as the LED lamp begins to emit light. The apparatus has a waterproof structure, and the manufacturing unit cost is low, so the apparatus of the present invention may be easily distributed to many small sized ships along with navigation or plotter display terminal apparatus.

### CROSS-REFERENCE TO PRIOR APPLICATIONS

This application claims priority of Korean Patent Application No. 10-2013-0136477, filed on Nov. 11, 2013, which is hereby incorporated by reference in its entirety.

### TECHNICAL FIELD

The present invention relates to a wireless communication apparatus of a ship for security, safety and emergency situation at sea, and in particular to a communication apparatus which is connected to a display apparatus for a navigation or a plotter and includes a function for transmitting and receiving message for a position information and additional service and a communication network which is separated in case of emergency situation in order for a ship, a deck officer and passenger to be rescued by transmitting the positions of the ship, sailor and passenger to a maritime rescue/salvage center while having a horizontal level maintaining function when being separately floated at sea along with waterproof function, water resistance function and communication performance function.

### BACKGROUND ART

The technology for transmitting the position of a ship to a maritime rescue/salvage center using a GPS function is disclosed in the Korean Patent Registration No. 10-0902400. Such a technology has been used at sea by deck officers and the maritime safety control center.

When an emergency situation occurs while a ship sails, the above-mentioned conventional technology is configured to transmit the position of the emergency situation to the control order or the rescue center for rescuing, so the safeties of many deck officers/passengers have been guaranteed.

Referring to the above-mentioned patent document, the document describes that an emergency situation informing unit includes a plurality of buttons, and different emergency situation information are set at each button. When any one of the buttons is pressed, a control module is configured to generate an emergency situation information set at the pressed button and transmit the generated emergency situation information to a control center using a communication module.

However, such a technology has a problem in that in case that a ship has an accident while it sails and the ship is flooded or sinks, it needs to transmit an emergency signal by manually operating a switch. The switch may be pushed even when it is not an emergency situation, so that false information may be subsequently transmitted. In particular, if the ship is positioned where zamming attacks frequently take place (west sea/sea off Incheon city) due to the disadvantages of the GPS (Global Positioning System) or it is hard to receive a position information from the GPS satellite due to bad weather, there may be errors in the scope, so the information of the positions may be unclear while the persons in emergency float at sea. If the technology having waterproof performance and functions are actually adopted to the product, the unit cost of the product greatly increases.

For the above-mentioned technology, the Korean Utility Model Publication No. 20-0242412 has been adopted. The above-mentioned technology is characterized in that buoyancy creates in a state where an additional apparatus separates from the ship while the ship sinks, a contracted spring expands, and a terminal contact switch is switched to an on state, and the plus terminal contacts with the minus terminal, and the battery plays as an electric power, so the electric power may be supplied to the GS receiver, the transmitter and the CPU (Central Processing Unit), and the system operates.

It is characterized in that the activated GPS receiver recognizes the position of the sunk ship with the aid of the GPS satellite and transmits a GPS signal to the CPU, and the CPU converts the signal received from the GPS receiver into a signal that the transmitter can transmit, and transmits to the transmitter. The transmitter transmits the converted position information to the land control center.

The above-mentioned technology has a problem in that the above-described system is designed to operate only when the ship is flooded, which means that the activation of the apparatus is limited, so it is impossible for the deck officer to activate the apparatus even when the deck officer judges the emergency situation.

As described earlier, the technology for tracing the ship or the deck officer who are in emergency at sea has been advanced a lot, but the technology for actually rescuing the deck officer is not yet developed in Korea. Therefore, there is a problem in that there is not any method to efficiently transmit the position information of the deck officer in emergency in order for a rescue ship, which receives the information, to easily rescue the deck officer, so the rescuing method for receiving information when the deck officer is in emergency in the middle of sailing is very limited.

### DISCLOSURE OF INVENTION

Accordingly, the present invention is made in an effort to resolve the above-described problems. It is an object of the present invention to provide a GPS-based wireless communication apparatus for periodic position information provision and search and rescue support, which may be used as an emergency rescue system when in emergency while being used as an apparatus for transmitting and receiving position information when the situation is normal. When a deck officer/passenger judges an emergency situation, the apparatus separates from a holding unit and at the same time it is automatically activated. It does not need to worry about error operation. When an emergency situation takes place, it is possible to easily locate and search the positions of the persons in emergency. The above apparatus has a waterproof structure, and the manufacturing unit cost is low, so the apparatus of the present invention may be easily distributed to many deck officers and persons who might be in emergency.

To achieve the above object, the present invention aims to provide a GPS-based wireless communication apparatus for the sake of search and rescue supports when in emergency or accident while periodically providing position information when the situation is normal, and when a deck officer judges an emergency situation, the apparatus separates from a holding unit and at the same time it is automatically activated. It does not need to worry about error operation. When an emergency situation takes place, it is possible to easily locate and search the positions of the persons in emergency. The above apparatus has a waterproof structure, and the manufacturing unit cost is low, so the apparatus of the present invention may be easily distributed to many deck officers who might be in emergency.

When performing such an object, the position information may be transmitted to or received from the control center or the rescue center through the GPS receiver 251 disposed at one side of the top of a reflection plate 250. A waterproof connector 210 is provided at one side of an inner circumferential surface of a frame and may be connected to a display apparatus.

When the situation is normal, the apparatus is engaged to the holding unit 300 and operates in a state where an engaging lower plate provided at the bottom of the holding unit 300 and a stand hatch 311 are tightly fixed, and the apparatus is configured to communicate with an additional display apparatus connected through a wire so as to periodically transmit and receive the position information. In a state where the apparatus is connected to the waterproof connector 210 and performs a control function while it is connected to the display apparatus, when an emergency situation takes place, the apparatus is separated from the holding unit 300 and at the same time the connection becomes disconnected as the engagement with the waterproof connector 210 is disengaged, so the inner circuit detects the above-mentioned state, and the detected state is converted into an emergency rescue signal (SOS) including the current position information, and the converted signal is transmitted to the head office.

After the signal is transmitted, the deck officer and the passenger may carry the apparatus with them or may float at sea, and a LED lamp 252 which corresponds to a GPS receiver 251 and is installed at the top of the reflection plate 250 emits light in order for the position of the deck officer to be informed.

### Advantageous Effects

According to the present invention, when the situation is normal, the position information is periodically transmitted. When the situation is in emergency or accident, and the deck officer judges the situation is an emergency situation, the GPS-based wireless communication apparatus for the sake of search and rescue is controlled to be activated, and it does not need to worry about error operation. After an emergency situation takes place, it is possible to easily locate the positions of the deck officers and search them. Since the waterproof structure is adopted, manufacturing unit cost is low, and the apparatus of the present invention may be easily distributed to many deck officers.

### BRIEF DESCRIPTION OF DRAWINGS

FIG. 1 is a perspective view illustrating in detail an exterior of the present invention including a string hanger 215 disposed at one side of an outer circumferential surface of a lower frame 200 according to the present invention.

FIG. 2 is a partial detail view illustrating a configuration of an assembling guide 229 when engaging a reflection plate 250 to a lower frame 200 according to the present invention.

FIG. 3 is a partial detail view illustrating in detail a rib portion of an antenna jack 110 according to the present invention.

FIG. 4 is a partial cross sectional view illustrating an engaged configuration of an antenna 111 and an antenna jack 110 according to the present invention.

FIG. 5 is a partial detail view illustrating in detail a configuration of a waterproof connector 210 disposed at a rear surface of a lower frame 200 according to the present invention.

FIG. 6 is a partial perspective view illustrating a configuration of a holding unit 300 according to the present invention.

FIG. 7 is a partial detail view illustrating a structure of a stopper 211 of a lower frame 200 according to the present invention.

FIG. 8 is a partial cross sectional view illustrating a lower frame 200 according to the present invention.

FIG. 9 is a partial detail view illustrating in detail a reflection plate 250 an its surrounding portions according to the present invention.

FIG. 10 is a partial rear view illustrating in detail part of a rear surface of a holding unit 300 according to the present invention.

FIG. 11 is a partially disassembled view illustrating in detail an engagement between a holding unit 300 and a waterproof connector 210 according to the present invention.

FIG. 12 is a detail partially disassembled view illustrating in detail an engagement between a holding unit 300 and a waterproof connector 210 according to the present invention.

### MODES FOR CARRYING OUT THE INVENTION

The present invention will be described along with embodiments with reference to the accompanying drawings.

### Exemplary Embodiment

When constituting the GPS-based wireless communication apparatus for the sake of search and rescue supports when in emergency and accident while periodically transmitting position information when the situation is normal, the apparatus includes a wireless communication apparatus and a holding unit 300 for holding and supporting the wireless communication apparatus.

The top of the wireless communication apparatus forms an upper frame 100, and the bottom of the wireless communication apparatus forms a lower frame 200, which are the collective terms.

The upper frame 100 is made from a transparent material, and an antenna jack 110 is disposed at the top of the upper frame 100.

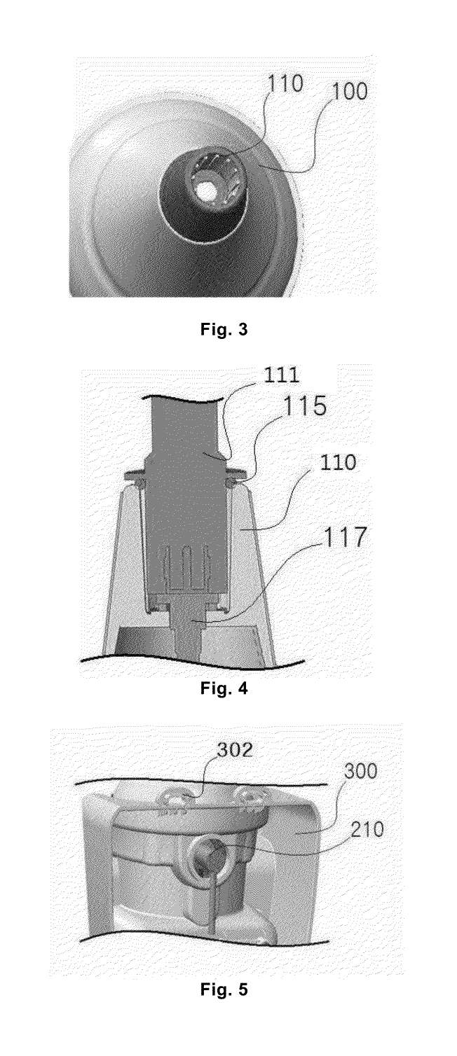

The antenna jack 110, as illustrated in FIG. 3, includes on its outer circumferential surface a plurality of ribs by means of which when the antenna 111 is engaged to the upper surface of the antenna jack 110, the engagement becomes tighter while preventing any transformation.

As illustrated in FIG. 4, the engagement of the antenna jack 110 and the antenna 111 has a waterproof function in such a way that a waterproof ring 115 is inserted between the bottom of the antenna 111 and the top of the antenna jack 110.

Here, the waterproof ring 115 is made of a flexible material, and it is preferred that the material of the waterproof ring 115 is silicon, rubber, etc.

A weight 220 and a battery 221 are provided at the inner lower side of the lower frame 200.

The weight 220 is made from miscellaneous steels the cost of which is very low and which has a weight heavy enough to balance the weight center by sinking the wireless communication apparatus under water. The weight 220 is disposed at the inner lower side of the lower frame 200 and has at its center a hole into which a battery/rechargeable battery may be inserted, and the top of the weight 220 is tapered.

The battery 221 is inserted into the inner circumferential surface of the weight 220. Since the diameter of the inner circumferential surface of the hole of the top of the weight 220 is larger than the diameter of the outer circumferential surface of the battery 221 so as to prevent explosion and abnormal state of the battery 221 which might occur due to the abnormal temperature or the internal temperature rise, it is characterized in that there remains a space. A cushion material is inserted into the upper side and the lower side of the battery so as to support the battery and mitigate the impacts.

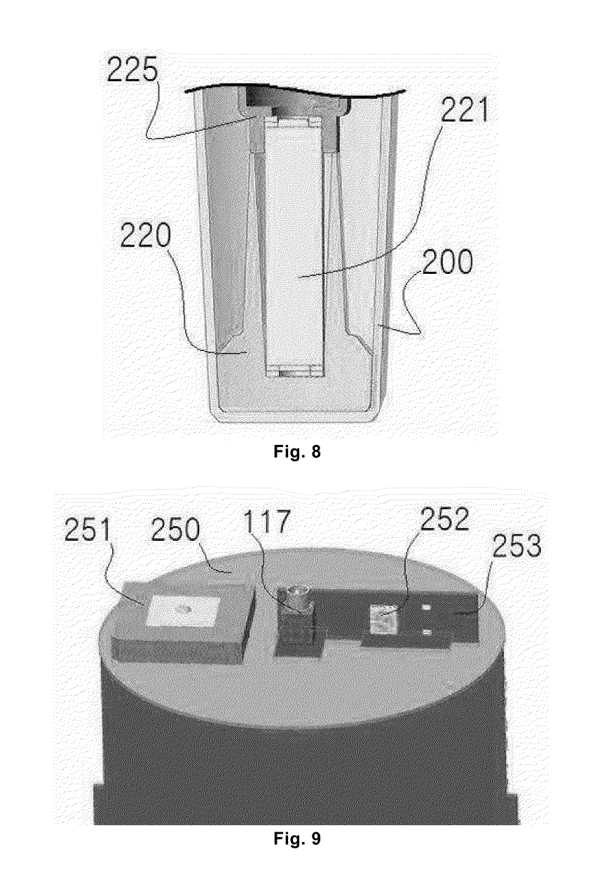

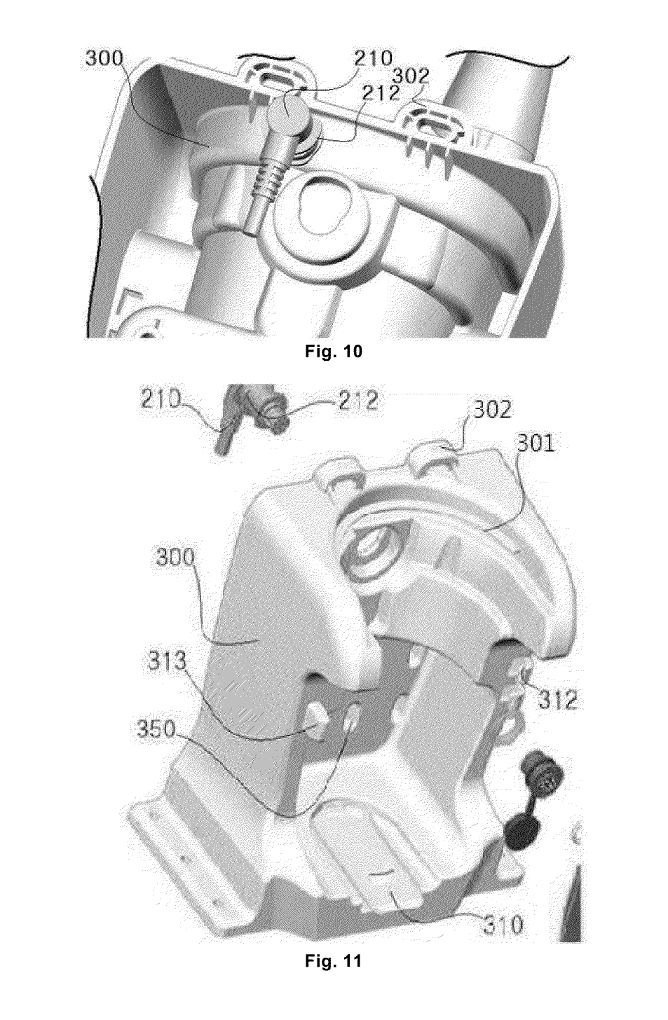

Referring to FIG. 8, since a top fixing plate 225 compress and supports the battery 221 and the weight 220 from the top, so the battery 221 may be fixed while preventing the weight 220 from moving.

Since the weight made from lead/steel having a high viscosity is positioned at the lower most portion of the apparatus according to the present invention, the apparatus may well balance and float at sea or freshwater when in emergency.

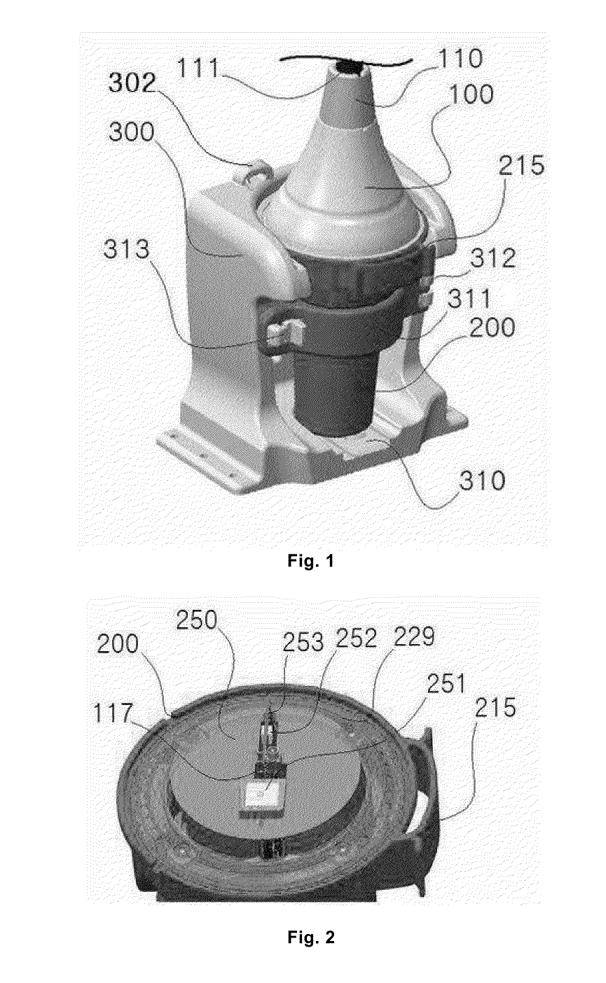

At this time, as illustrated in FIG. 2, an assembling guide 229 is engaged to the top of the top fixing plate 225, so it may be more stably engaged to the lower frame 200, and water may not penetrate into the top fixing plate 225.

As illustrated in FIG. 9, a reflection plate 250 having a diameter corresponding to the inner circumferential surface of the assembling guide 229 is provided at the top of the inner circumferential surface of the lower frame 200, and an antenna cable 117 is provided at the center thereof. The antenna cable 117 extends up to the top of the inner circumferential surface of the upper frame and is connected to the bottom of the antenna jack 110.

Therefore, the position information may be transmitted to or may be received from the control center or the rescue center through the GPS receiver 251 provided at one side of the upper surface of the reflection plate 250.

The LED lamp 252 installed at the upper surface of the reflection plate 250 while corresponding to the GPS receiver 251 is characterized in that the head of the lamp faces in the horizontal direction so as to amplify the light by allowing the reflection plate 250 to reflect the light. At this time, both ends of the same are positioned higher than the portion where water floods in the vertically standing PCB substrate 253.

At this time, the PCB substrate 253 is an operation circuit of the apparatus and serves to perform the comprehensive controls of the apparatus at the center of the reflection plate 250 in the vertical direction, and when in emergency, the LED lamp 252 is turned on, and the current position is transmitted to the control center or the rescue center of the land.

Therefore, the material of the reflection plate 250 should be a material which may easily reflect light. When the LED lamp 252 is turned on as the emergency situation takes place, the range and power of the light may be more amplified in order for other deck officers or rescue ships to quickly locate and rescue the persons in emergency.

With regard to the storage of the apparatus, when the situation is normal, the wireless communication apparatus is engaged to the holding unit 300. A plurality of stoppers 211 as illustrated in FIG. 7 are provided at regular intervals at a partial portion of the outer circumferential surface of the lower frame 200.

At this time, a partial portion of the holding unit 400 is concavely grooved in the same shape as the shape of the stopper 211 of the lower frame 200.

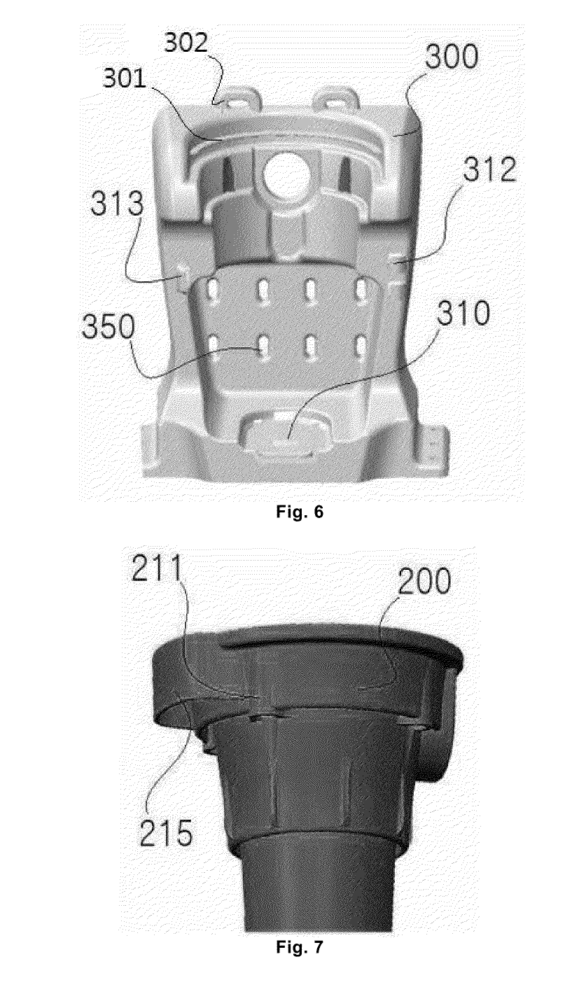

As illustrated in FIG. 6, a guider 301 is provided at the top of the inner circumferential surface of the holding unit 300 for guiding the same in order for the wireless communication apparatus to be easily inserted into or be unfolded, while performing a role where the wireless communication apparatus is caught in place so that the wireless communication apparatus doe not separate by vibrations or impacts.

The engaging lower plate 310 and the stand hatch 311 disposed at the bottom of the holding unit 300 serve to tightly fix the lower frame 200.

At this time, the engaging lower plate 310 is spaced apart from the bottom of the inner circumferential surface of the holding unit 300, and a hook is formed at the front end of the engaging lower plate 310.

In addition, the stand hatch 311 performs a function of the opening and closing ports of the holding unit 300. A hinge unit 312 is formed at any one end of both ends of the outer circumferential surface of the holding unit 300, and a locking hinge unit 313 is formed at the opposite portion, so that the stand hatch may be inserted into the hinge unit 312, and the clip is hooked by the locking hinge unit 313, whereby it may be fixed in the closed state as illustrated in FIG. 1.

In order for the apparatus to be hung on a portion like a wall, etc., as illustrated in FIG. 6, there are provided a plurality of holding and assembling holes 350 formed at regular intervals at the lower side of the rear surface of the holding unit 300.

A plurality of fixing rings 302 are provided on the upper surface of the holding unit 300.

It is characterized in that when installing the wireless communication apparatus, there is provided a ring through which a string is inserted for hereby fixedly installing the holding unit, and the rear surface is reinforced by the rib flesh.

When manufacturing the holding unit 300, all the inner fleshes are removed, and instead the rib fleshes are added to the rear surface, so the holing unit 300 may be manufactured at lower cost, and a strong exterior may be obtained.

With regard to the operation of the apparatus, the waterproof connector 210 is provided at one side of the inner circumferential surface of the lower frame 200 like the configuration as illustrated in FIG. 5, so that it is connected to the display apparatus when the situation is normal for thereby performing the function of the control.

At this time, the waterproof connector 210 has one side end which protrudes and is hung on the hole formed at the rear surface of the holding unit 300 and has a layer on which the waterproof connector 210 is hooked and positioned when it is connected to the wireless communication apparatus.

At this time, the waterproof connector 210 is characterized in that there is a wall from the connection portion with respect to the holding unit 300 so that external water does not overflow and move into the interior of the cable of the waterproof connector 210 for thereby preventing any possibility for the flow of water.

A molding 212 protrudes from one side end wherein the molding 212 can be fixedly inserted into a hole formed at the rear surface of the holding unit 300 when the waterproof connector 210 is inserted into the holding unit 300 of the wireless communication apparatus and is connected thereto so as to obtain the above function, for thereby obtaining an engagement as illustrated in FIG. 11.

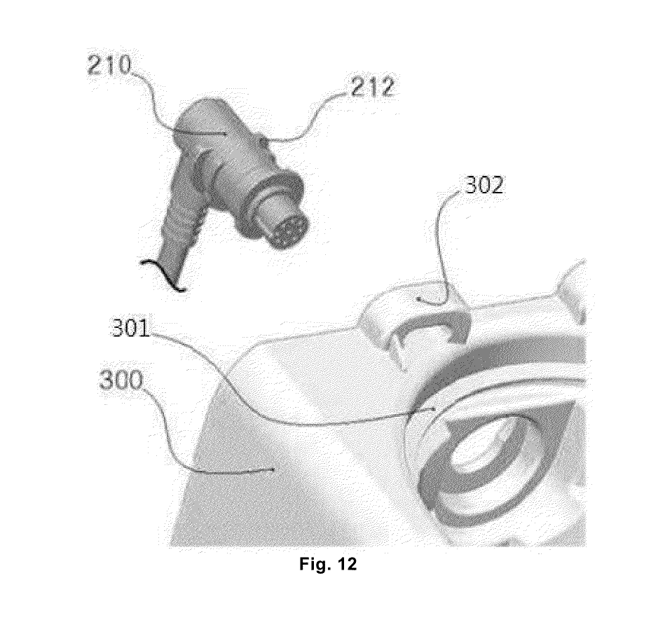

At this time, when enlarging the configuration in FIG. 11, it becomes the configuration in FIG. 12.

Therefore, the apparatus is configured in such a way that since the emergency situation takes place, when the deck officer disengages the engagement from the holding unit 300, the connection with the waterproof connector 210 is simultaneously disconnected, and the position information is transmitted to the control center or the rescue center through the GPS receiver 251.

The deck officer may carry the apparatus with him after the transmission, and the LED lamp 252 installed at the upper surface of the reflection plate 250 while corresponding to the GPS receiver 251 emits light, so that the position information of the deck officer may be informed.

At this time, the user should prepare for wave, etc. while carrying the apparatus with him. In this case, the user takes out a strip from a strip hanger 215 provided at one side end of the outer circumferential surface of the lower frame 200 and uses it all the time.

The scope of the claims of the instrument engagement structure of the wireless communication apparatus of a ship for security, safety and emergency situation at sea may be limited based on the above description, but the actual scope of the implementation affects the cope where the user may easily deduct and implement.

### LEGEND OF REFERENCE NUMBER

| | |
|---|---|
| 100: upper frame | 110: antenna jack |
| 111: antenna | 115: waterproof ring |
| 117: antenna cable | 200: lower frame |
| 210: waterproof connector | 212: molding |
| 211: stopper | 215: string hanger |
| 220: weight | 221: battery |
| 225: upper fixing plate | 229: assembling guide |
| 250: reflection plate | 251: GPS receiver |
| 252: LED lamp | 253: PCB substrate |
| 300: holding unit | 301: guider |
| 302: fixing ring | 310: engaging lower plate |
| 311: stand hatch | 312: hinge unit |
| 313: locking hinge unit | 350: holding and assembling |
| | hole |

What is claimed is:

1. A detachable wireless communication apparatus and holding unit of a ship for security, safety and emergency situation at sea, comprising:
an upper frame which is disposed at the top of the wireless communication apparatus;
a lower frame which is disposed at the bottom of the wireless communication apparatus;
an antenna jack which is provided at the top of the upper frame;
an antenna which is engaged to the top of the upper surface of the antenna jack;
a waterproof connector which is provided at one side of an inner circumferential surface of the lower frame;
a weight which is provided at the inner lower side of the lower frame;
a battery which is inserted into an inner circumferential surface of the weight; and
a reflection plate which is disposed at the top of the inner circumferential surface of the lower frame; and
a holder unit.

2. The apparatus of claim 1, further comprising:
a GPS receiver which is provided at one side of the top of the reflection plate 250; and
a LED lamp which is provided at an upper surface of the reflection plate while corresponding to the GPS receiver and is configured to be provided at least on one side of a PCB substrate.

3. The apparatus of claim 1, further comprising:
a waterproof ring disposed between the bottom of the antenna and the top of the antenna jack; and
an antenna cable which extends up to the top of the inner circumferential surface of the upper frame and is connected to the bottom of the antenna jack.

4. The apparatus of claim 1, further comprising:
a top fixing plate configured to compress and support the battery and the top of the weight; and
an assembling guide which is attached to the top of the top fixing plate.

5. A holding unit for supporting a wireless communication apparatus of a ship for security, safety and emergency situation at sea, comprising:
an engaging lower plate which is spaced apart from the bottom of its inner circumferential surface and has a hook at the front side of the engaging lower plate;
a hinge unit which is formed at any one side of the outer circumferential surface;
a locking hinge unit which is formed at the opposite side of the hinge unit; and
a stand hatch which is inserted into the hinge unit and is configured to clip on the locking hinge unit.

6. The apparatus of claim 1, wherein a strip hanger is provided at one side of the outer circumferential surface of the lower frame.

7. The holding unit of claim 5, further comprising:
a plurality of fixing rings which are provided at the upper surface of the holding unit; and
a guider which is provided at the top of the inner circumferential surface of the holding unit.
